(19) United States
(12) Patent Application Publication
(10) Pub. No.: US 2012/0145136 A1
(43) Pub. Date: Jun. 14, 2012

(54) MULTI-EVENT CORONA DISCHARGE IGNITION ASSEMBLY AND METHOD OF CONTROL AND OPERATION

(76) Inventors: John Antony Burrows, Norwich (GB); James D. Lykowski, Temperance, MI (US)

(21) Appl. No.: 13/325,375

(22) Filed: Dec. 14, 2011

Related U.S. Application Data
(60) Provisional application No. 61/422,824, filed on Dec. 14, 2010.

(51) Int. Cl. F02P 3/01; F23Q 3/00

(52) U.S. Cl. 123/608; 361/263

(57) ABSTRACT

A corona discharge ignition system 20 includes an igniter 22 for receiving pulses of electrical energy each having a radio frequency. The igniter 22 emits pulses of electrical field ionizing a fuel-air mixture and providing pulses of corona discharge 24, rather than a continuous, un-pulsed corona discharge over the same period of time. The system 20 includes at least one power supply 48, 50 providing the electrical energy to a corona drive circuit 52 and ultimately to the igniter 22. The system 20 can include a variable high voltage power supply 50 and a local charge storage device 70 for providing pulses of the electrical energy to the corona drive circuit 52. The system 20 provides a robust ignition comparable to a single event corona discharge ignition system, with improved resistance to arc formation, while using a fraction of the energy.

### CROSS REFERENCE TO RELATED APPLICATION

This application claims the benefit of U.S. Provisional Application Ser. No. 61/422,824, filed Dec. 14, 2010.

### BACKGROUND OF THE INVENTION

1. Field of the Invention

This invention relates generally to a corona discharge ignition system, and a method of igniting a fuel-air mixture using corona discharge.

2. Related Art

An example of a corona discharge ignition system is disclosed in U.S. Pat. No. 6,883,507 to Freen. The corona discharge ignition system includes an igniter with an electrode charged to a high radio frequency voltage potential, providing an electrical field having a radio frequency in a combustion chamber. The igniter does not include any grounded electrode element in close proximity to the firing tip. Rather, the ground is typically provided by walls of the combustion chamber or a piston. An example of a corona igniter is disclosed in U.S. Patent Application Publication No. US 2010/0083942 to Lykowski et al.

The electrical field provided by the igniter causes a portion of a mixture of fuel and air in the combustion chamber to ionize and begin dielectric breakdown, facilitating ignition of the fuel-air mixture. The electrical field is preferably controlled so that the fuel-air mixture maintains dielectric properties and corona discharge occurs, also referred to as a non-thermal plasma. The ionized portion of the fuel-air mixture forms a flame front which then becomes self-sustaining and ignites the remaining portion of the fuel-air mixture. Preferably, the electrical field is also controlled so that the fuel-air mixture does not lose all dielectric properties, which would create a thermal plasma and an electric arc between the electrode and grounded cylinder walls or piston.

To achieve reliable ignition of the fuel-air mixture, a minimum corona discharge strength is oftentimes required. A continuous corona discharge ignition event having a certain duration is typically necessary to provide the required minimum strength when using very lean or dilute fuel-air mixtures. However, a long duration requires high energy usage and related energy costs. In addition, the system requires sophisticated electronics capable of handling the high energy loads. Further, the longer the duration, the more likely it is that the corona discharge will encounter the grounded piston or combustion chamber walls, creating arcing, and preventing the corona discharge from taking any other path.

### SUMMARY OF THE INVENTION

One aspect of the invention includes a corona discharge ignition system for providing corona discharge to ignite a fuel-air mixture. The system includes at least one power supply providing electrical energy having a radio frequency. An igniter receives a plurality of pulses of the electrical energy and provides a plurality of pulses of the corona discharge.

Another aspect of the invention provides a method of igniting a fuel-air mixture using corona discharge. The method includes providing a plurality of pulses of electrical energy having a radio frequency to an igniter, and providing a plurality of pulses of corona discharge from the igniter.

The pulsed corona discharge provides a multi-event ignition of the fuel-air mixture with numerous benefits, including reduced energy usage and costs, simplification of electronic components, reduced arcing, and higher voltage and volume of corona discharge, compared to other corona discharge ignition systems providing a single event with a continuous, non-pulsed corona discharge.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a cross-sectional view of an igniter disposed in a combustion chamber of a corona discharge ignition system according to one embodiment of the invention,

FIG. 2A is a diagram of electronic components of the corona discharge ignition system without a local charge storage device according to one embodiment of the invention;

FIG. 2B includes a graphs illustrating the timing of the ignition event and corona discharge of the system of FIG. 2A;

FIG. 3A is a diagram of electronic components of the corona discharge ignition system of FIG. 2,

FIG. 3B is a graph illustrating current, voltage, and timing employed in a single event corona discharge ignition system of the prior art,

FIG. 3C is a graph illustrating current, voltage, and timing employed in the embodiment of FIGS. 2 and 3A,

FIG. 4A is a diagram of electronic components of the corona discharge ignition system with a local charge storage device according to another embodiment of the invention;

FIG. 4B includes graphs illustrating the timing of the ignition event and corona discharge of the system of FIG. 4A;

FIG. 5A is a diagram of electronic components of the corona discharge ignition system of FIG. 4,

FIG. 5B is a graph illustrating current, voltage, and timing employed in the embodiment of FIGS. 4 and 5A,

FIG. 5C is a graph illustrating current, voltage, and timing employed in a single event corona discharge ignition system of the prior art with a local charge storage device, and

FIG. 6 includes graphs comparing the energy usage of the inventive corona discharge ignition system to systems of the prior art.

### DETAILED DESCRIPTION

One aspect of the invention provides a corona discharge ignition system 20 including an igniter 22 receiving pulses of electrical energy each having a radio frequency and emitting pulses of electrical field each having a radio frequency. The pulses of electrical field ionize a portion of a fuel-air mixture and provide pulses of corona discharge 24 over a period of time, rather than a continuous corona discharge over the same period of time. The pulsed corona discharge 24 provides a multi-event ignition of the fuel-air mixture with numerous benefits, including reduced energy usage and costs, simplification of electronic components, reduced arcing, and higher voltage and volume of corona discharge 24, compared to the prior art systems providing single event ignition using a continuous, non-pulsed, corona discharge.

The igniter 22 of the corona discharge ignition system 20 includes an electrode 26 having a center axis extending longitudinally from an electrode terminal end 28 to an electrode firing end 30. The electrode 26 receives the pulses of electrical energy at the electrode terminal end 28 and emits the pulses of electrical field from the electrode firing end 30. The electrode 26 includes an electrode body portion 32 formed of a first electrically conductive material, such as nickel, extending longitudinally from the electrode terminal end 28 along the center axis to the electrode firing end 30. In one embodiment, the electrode 26 includes a firing tip 34 at the electrode firing end 30 for emitting the pulses of electrical field to ionize a portion of the fuel-air mixture and provide the corona discharge 24.

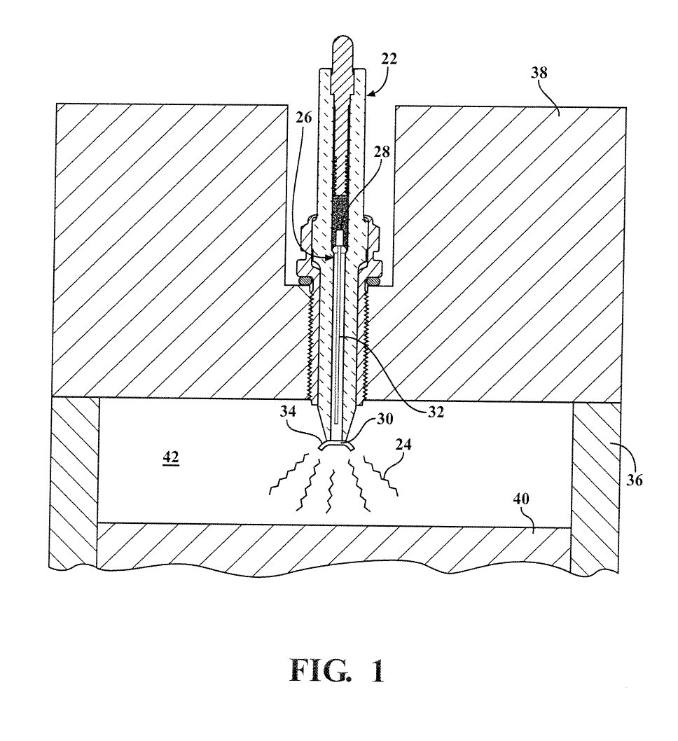

In one embodiment, the corona discharge ignition system 20 is part of an internal combustion engine of an automotive vehicle. As shown in FIG. 1, the internal combustion engine includes a cylinder block 36 having a side wall extending circumferentially around a center axis and presenting a space having a cylindrical shape. The side walls have a top end surrounding a top opening. A cylinder head 38 is disposed on the top end of the side walls and extends across the top opening of the cylinder block 36. A piston 40 is disposed in the cylindrical space and along the side wall of the cylinder block 36 for sliding along the side wall during operation of the internal combustion engine. The piston 40 is spaced from the cylinder head 38 so that the cylinder block 36 and the cylinder head 38 and the piston 40 together provide the combustion chamber 42 therebetween for containing the fuel-air mixture. The fuel-air mixture moves continuously throughout the combustion chamber 42 during operation of the internal combustion engine.

As shown in FIG. 1, the igniter 22 is disposed in the cylinder head 38 and extends transversely into the combustion chamber 42. As alluded to above, the igniter 22 receives the electrical energy at a radio frequency of 700 kHz to 2 MHz. Each pulse of electrical energy received by the igniter 22 meets certain parameters, referred to as calculated energy parameters. The calculated energy parameters include the frequency, duration, interval, and voltage of the pulse. The pulses of electrical energy provided to the igniter 22 may be stronger than the electrical energy provided to an igniter 22 of the single ignition event system using an un-pulsed, continuous corona discharge. In one embodiment, each pulse of electrical energy has a voltage of 100 to 1000 volts and a current of 0.1 to 5 A.

The pulses of electrical energy received by the igniter 22 have no minimum duration, but the duration is typically tens of microseconds. In one embodiment, the pulses of electrical energy received by the igniter 22 each have a duration of 1 microsecond to 2,500 microseconds, or 1 to 100 microseconds, or preferably 20 to 30 microseconds. Each pulse of electrical energy is spaced from the next pulse by an interval of time wherein no electrical energy is received by the igniter 22. The interval between pulses has no minimum duration, but the duration of the interval is typically tens of microseconds. In one embodiment, each pulse of electrical energy is spaced from the next pulse by an interval of 1 microsecond to 2,500 microseconds, or 1 to 100 microseconds, or preferably 20 to 30 microseconds. Although the duration of the pulses and the intervals between the pulses are typically tens of microseconds, the frequency of the pulses could be unlimited. In one embodiment, the pulses of energy have a frequency of at least 400 Hertz, or 400 to 50,000 Hertz.

As stated above, the firing tip 34 of the igniter 22 emits the electrical field having a frequency of 700 kHz to 2 MHz to ionize a portion of the fuel-air mixture and form the corona discharge 24. The electrical field and the corona discharge 24 are also provided as pulses. The pulses of electrical field emitted from the igniter 22 may be stronger than the electrical field emitted from an igniter 22 of a single event system with a continuous corona discharge. In one embodiment, each pulse of electrical field has a voltage of 1,000 to 100,000 volts and a current up to 100 mA.

The duration of each pulse of electrical field emitted from the igniter 22 has no minimum, but is typically tens of microseconds. In one embodiment, the pulses of electrical field emitted by the igniter 22 each have a duration of 1 microseconds to 2500 microseconds, or 1 to 100 microseconds, or preferably 20 to 30 microseconds. Each pulse of electrical field emitted by the igniter 22 is spaced from the next pulse by an interval of time wherein no electrical field is emitted by the igniter 22. The duration of the interval has no minimum, but is typically tens of microseconds. In one embodiment, each pulse of electrical field is spaced from the next pulse by an interval of 1 microsecond to 2,500 microseconds, or 1 to 100 microseconds, or preferably 20 to 30 microseconds. Although the duration of the pulses and the intervals between the pulses are typically tens of microseconds, the frequency of the pulses could be unlimited. In one embodiment, the pulses of electrical field have a frequency of at least 400 Hertz, or 400 to 50,000 Hertz.

The duration of the pulses of corona discharge 24 provided in the combustion chamber 42 igniting the fuel-air mixture also have no minimum, but the duration is typically tens of microseconds. In one embodiment, the pulses of corona discharge 24 provided in the combustion chamber 42 have a duration of 1 microsecond to 2,500 microseconds, or 1 to 100 microseconds, or preferably 20 to 30 microseconds. Each of the pulses of corona discharge 24 are spaced from the next one of the pulses by an interval of time wherein no corona discharge 24 is provided. The duration of the interval has no minimum, but is typically tens of microseconds. In one embodiment, each pulse of corona discharge 24 is spaced from the next pulse by an interval of 1 microsecond to 2,500 microseconds, or 1 to 100 microseconds, or preferably 20 to 30 microseconds. Although the duration of the pulses and the intervals between the pulses are typically tens of microseconds, the frequency of the pulses could be unlimited. In one embodiment, the pulses of corona discharge 24 have a frequency of at least 400 Hertz, or 400 to 50,000 Hertz.

The strength of ignition provided by the pulsed corona discharge 24 of the present invention is comparable to the ignition provided by the single event corona discharge ignition systems with the continuous, un-pulsed corona discharge. The fuel-air mixture in the combustion chamber 42 is continuously moving and therefore is effectively exposed to the pulsed corona discharge 24, at about the same level as if the corona discharge 24 were continuous. However, as stated above, the system 20 of the present invention provides ignition using a fraction of the energy used by other systems.

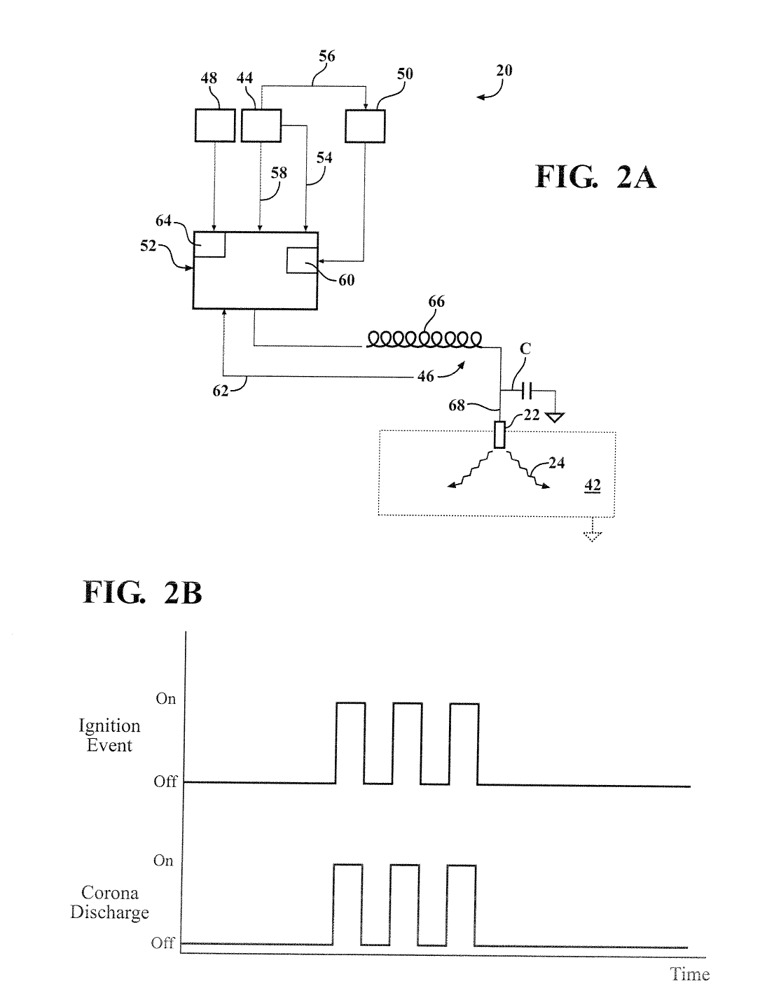

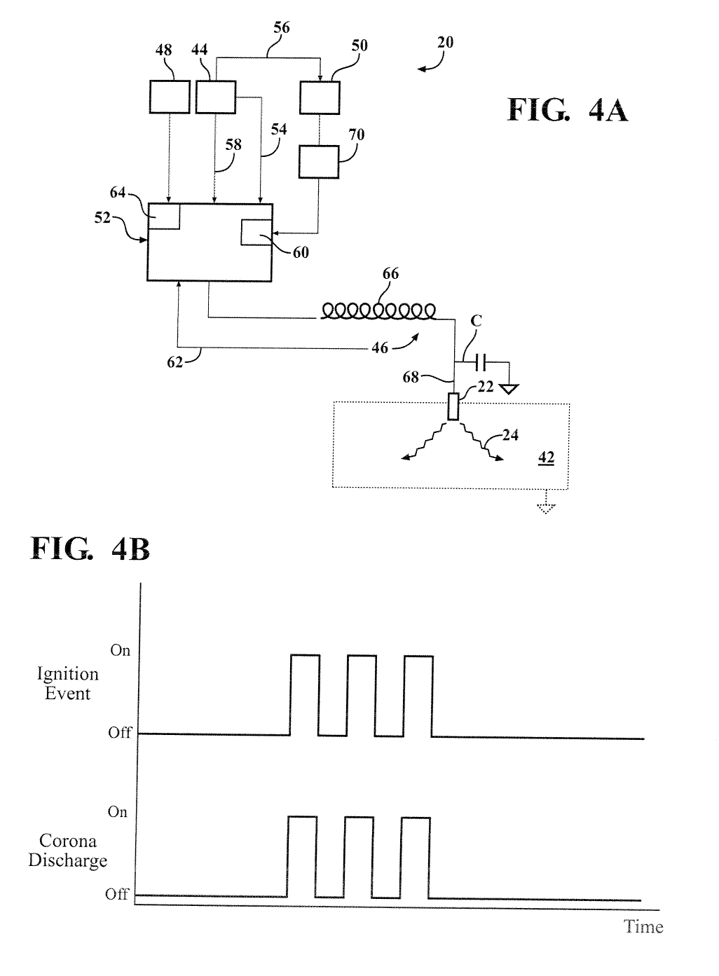

Electronic components of the corona discharge ignition system 20 providing the pulsed corona discharge 24 are generally shown in FIGS. 2A and 4A. Graphs illustrating the timing of the pulsed corona discharge 24 and ignition of the fuel-air mixture are also shown in FIGS. 2B and 4B. The corona discharge ignition system 20 typically includes a controller 44, a tuned or LC circuit 46, at least one power supply 48, 50, and a firing end assembly. As alluded to above, the corona discharge 24 ignition system 20 is typically employed in an internal combustion engine of an automotive vehicle, but can be employed in other engine systems 20, such as stationary industrial engines, off-highway engines, gas engines, and compression-ignition engines.

The power supplies 48, 50 of the corona discharge ignition system 20 include a main power supply 48, which provides electrical energy to the corona drive circuit 52. The main power supply 48 may be a 12 volt battery of the automotive vehicle. In one embodiment, the corona discharge ignition system 20 includes a variable high voltage power supply 50, which also supplies electrical energy to the corona drive circuit 52 and ultimately to the igniter 22. The variable high voltage power supply 50 typically stores energy at a voltage of 10 to 150 volts and transmits the stored energy to the corona drive circuit 52 at a voltage of 10 to 150 volts. However, the variable high voltage power supply 50 is not required, and all the electrical energy may be provided by a single power supply, such as the main power supply 48. The power supplies 48, 50 can provide the electrical energy to the corona drive circuit 52 while corona discharge 24 is being produced, so that the corona drive circuit 52 is re-energized before the corona discharge 24 has decayed. Thus, there is no time required to recharge the system 20.

The corona drive circuit 52 receives the electrical energy from the power supplies 48, 50, stores the electrical energy, and then transmits the electrical energy to the LC circuit 46 and ultimately to the igniter 22. The corona drive circuit 52 is typically an oscillating circuit operating at a frequency of 700 kHz to 2 MHz. The electrical energy provided to the igniter 22 by the corona drive circuit 52 meets the calculated energy parameters discussed above. The calculated energy parameters can be determined using a variety of technical information, including engine data provided by the ECU and a resonance frequency of the system 20. In one embodiment, as shown in FIGS. 2A and 4A, the engine data is provided to the corona drive circuit 52 in an engine data signal 54, and the corona drive circuit 52 uses the engine data to determine the calculated energy parameters.

The controller 44 may be integrated with the ECU of the automotive vehicle, or may be a separate unit. In one embodiment, the controller 44 is used to determine the calculated energy parameters of the corona ignition system 20. In another embodiment, the calculated energy parameters are provided to the system 20 or programmed in the system 20. The controller 44 can also transmit a voltage signal 56 to the variable high voltage power supply 50 instructing the variable high voltage power supply 50 to transmit the electrical energy to the corona drive circuit 52 at a certain voltage.

As shown in FIGS. 2A and 4A, the controller 44 transmits a drive control signal 58 to the corona drive circuit 52 to activate or deactivate the corona drive circuit 52 and thus provide the pulsed corona discharge 24. To activate the corona drive circuit 52, the drive control signal 58 instructs the corona drive circuit 52 to transmit a pulse of the electrical energy to the igniter 22 having the duration and according to the other calculated energy parameters discussed above. The controller 44 transmits another drive control signal 58 deactivating the corona drive circuit 52. To deactivate the corona drive circuit 52, the drive control signal 58 instructs the corona drive circuit 52 to store the electrical energy and not transmit the electrical energy to the igniter 22 for the interval of time. Another drive control signal 58 then reactivates the corona drive circuit 52 by instructing the corona drive circuit 52 to transmit another pulse of the electrical energy to the igniter 22. The activating and deactivating steps are repeated to provide the pulsed corona discharge 24.

The corona drive circuit 52 includes at least one corona driver 60 for receiving the electrical energy from the main power supply 48 and the variable high voltage power supply 50 and the drive control signal 58. The corona driver 60 transmits the electrical energy to the LC circuit 46 and ultimately to the igniter 22, according to the calculated energy parameters.

Prior to transmitting the electrical energy to the LC circuit 46, the corona drive circuit 52 transforms or manipulates the electrical energy received by the power supplies 48, 50 to meet the calculated energy parameters. In addition to the drive control signal 58, the corona drive circuit 52 also receives a feedback loop signal 62 from the LC circuit 46 indicating a resonance frequency of the system 20. As stated above, the calculated energy parameters depend in part on the resonance frequency of the system 20. The corona drive circuit 52 typically includes a transformer 64 for manipulating the electrical energy to meet the calculated energy parameters. The corona drive circuit 52 transforms the electrical energy into an AC voltage, and transmits the AC voltage to the LC circuit 46.

The LC circuit 46 receives the AC current of electrical energy from the corona drive circuit 52 and also transforms the electrical energy according to the calculated energy parameters prior to transmitting the electrical energy to the igniter 22. The LC circuit 46 includes a resonating inductor 66 and a capacitance C provided by the firing end assembly. The firing end assembly includes the igniter 22 disposed in the combustion chamber 42. In one embodiment, the resonating inductor 66 is a coil of metal operating at a particular voltage and resonance frequency. As stated above, the LC circuit 46 transmits the feedback loop signal 62 to the corona drive circuit 52 indicating the resonance frequency. In one embodiment, the LC circuit 46 transforms the electrical energy prior to transmitting the energy to the igniter 22 by amplifying the voltage and decreasing the current. At least one electrical connection 68 is provided between the resonating inductor 66 and the igniter 22 for transmitting the electrical energy from the LC circuit 46 to the igniter 22.

As stated above, the electrode 26 of the igniter 22 receives the pulses of electrical energy from the LC circuit 46. Each pulse of electrical energy typically has a duration of 1 microsecond to 2,500 microseconds and is spaced from the next pulse by an interval of 1 microsecond to 2,500 microseconds. The pulses of electrical energy received by the electrode 26 of the igniter 22 typically have a current from 0.1 A to 5 A. The voltage and resonance of the pulsed electrical energy causes the electrode 26 to emit the pulsed electrical field in the combustion chamber 42, which ionizes a portion of the fuel-air mixture and provides the pulsed corona discharge 24 in the combustion chamber 42.

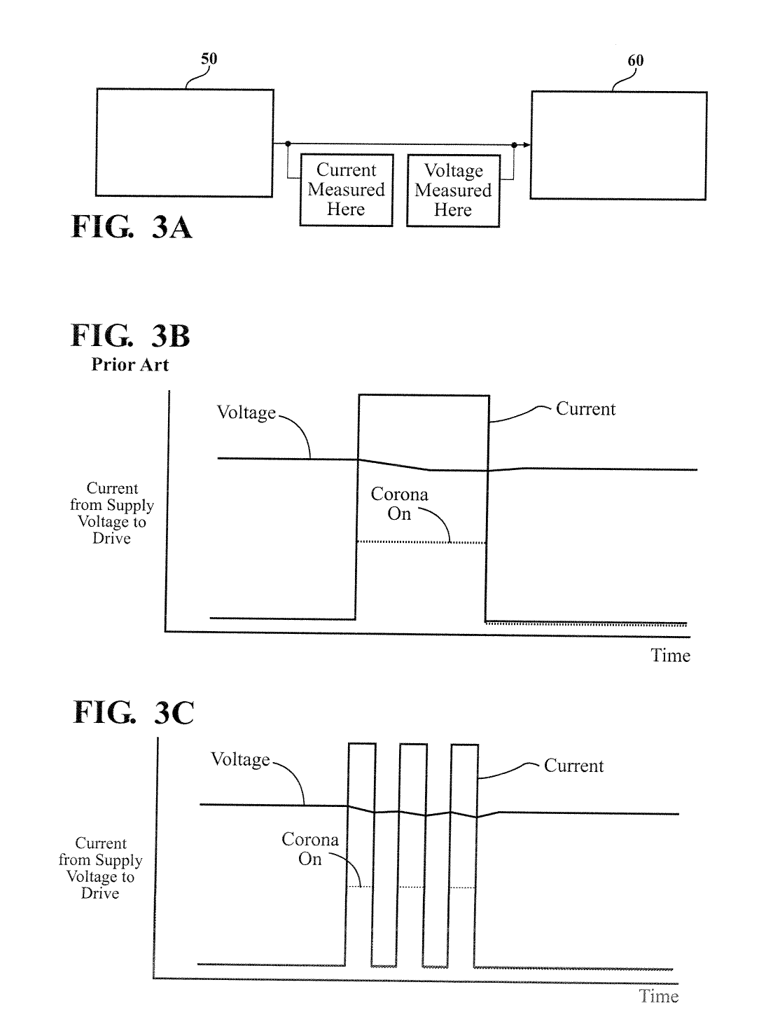

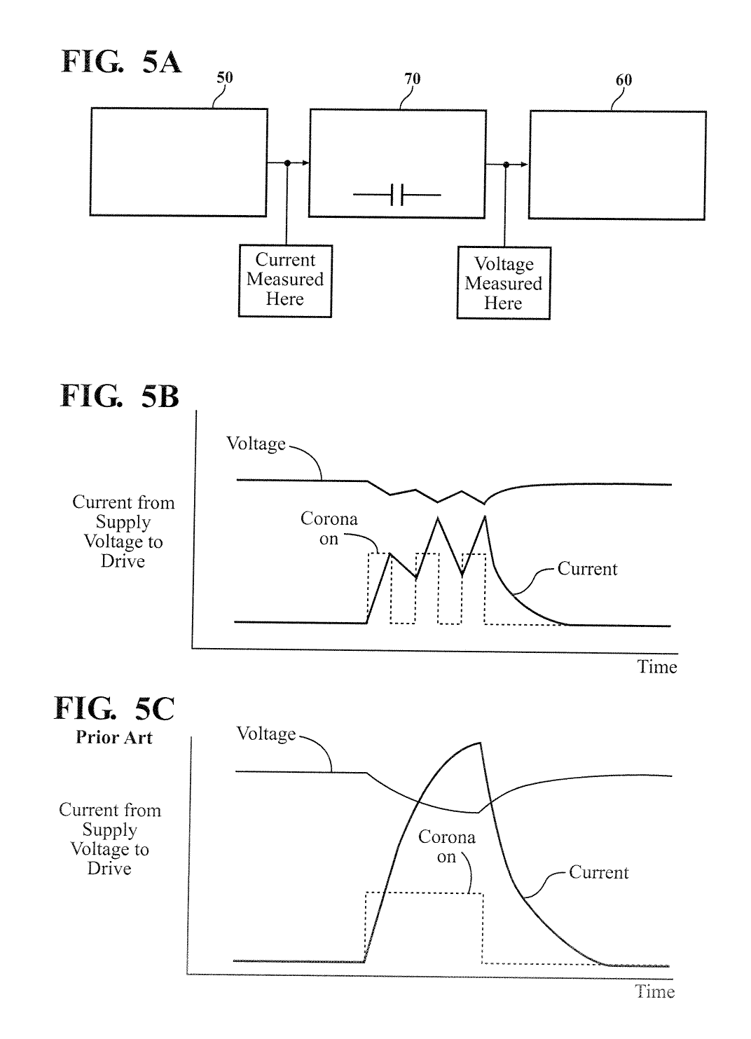

As stated above, in one embodiment, the corona discharge ignition system 20 includes a high voltage power supply 50 storing electrical energy and providing the electrical energy to the corona drive circuit 52. In this embodiment, the system 20 can also include a local charge storage device 70 between the high voltage power supply 50 and the corona driver 60 of the corona drive circuit 52, as shown in FIGS. 4A and 5A. The local charge storage device 70 is not required, as shown in FIGS. 2A and 3A. The local charge storage device 70 typically includes a capacitance and continuously receives electrical energy from the high voltage power supply 50. The electrical energy received by the high voltage power supply 50 typically is at a voltage of 10 to 150 volts. When energy stored in the corona drive circuit 52 is depleted, the corona driver 60 obtains pulses of the electrical energy from the local charge storage device 70. The pulses of electrical energy obtained from the local charge storage device 70 typically have a duration of 1 microseconds to 2500 microseconds and are spaced from one another by an interval of 1 microsecond to 2,500 microseconds. The pulses of electrical energy transmitted from the local charge storage device 70 have a greater current than the continuous flow of electrical energy received by the local charge storage device 70.

FIG. 3C is a graph illustrating the current from the variable high voltage power supply 50, voltage to the corona driver 60, and timing of the corona discharge 24 over a period of time for the embodiment without the local charge storage device 70, and FIG. 5B is a graph illustrating the current, voltage, and timing over the same period of time of the embodiment with the local charge storage device 70. FIGS. 3B and 5C are comparative graphs illustrating the current, voltage, and timing of a single ignition event system of the prior art providing a continuous, un-pulsed corona discharge over the same period of time, without and with the local charge storage device 70, respectively. The timing of the corona discharge 24 is shown by dotted lines.

In the embodiment of FIGS. 2 and 3A without the local charge storage device 70, the current of the electrical energy is measured when the electrical energy leaves the variable high voltage power supply 50 and the voltage is measured as the electrical energy enters the corona driver 60. In the embodiment of FIGS. 4A and 5A with the local charge storage device 70, the current of the electrical energy is measured when the electrical energy is transmitted from the variable high voltage power supply 50 before being received by the local charge storage device 70, and the voltage is measured after the electrical energy is transmitted from the local charge storage device 70 before being received by the corona driver 60.

The graphs of FIGS. 3C and 5B illustrate both inventive embodiments provide a comparable voltage with lower average current and lower energy usage than systems of the prior art providing the continuous, un-pulsed corona discharge. FIG. 5B shows that the local charge storage device 70 smoothes the average current and thus provides a lower average current compared to the embodiment of FIGS. 2 and 3A without the local charge storage device 70. The local charge storage device 70 is preferably used to prevent the variable high voltage power supply 50 from being rated for the maximum possible current required by the igniter 22.

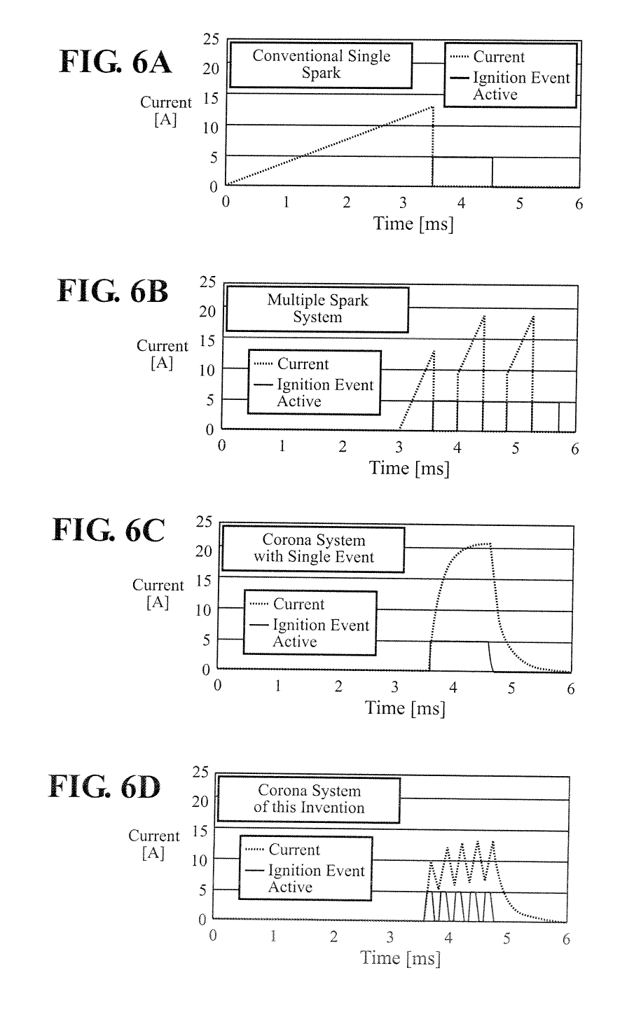

FIGS. 6A-D compares the energy usage of the inventive corona discharge 24 ignition system 20 to a corona discharge ignition system with a single ignition event, spark ignition system with a single spark event, and a spark ignition system with multiple spark events, over the same period of time. FIG. 6 illustrates the current and energy used by the inventive pulsed corona discharge system 20 is significantly less than the prior art systems. FIG. 6 also shows the inventive system 20 provides a low duty cycle of 50%. However, under certain conditions, a duty cycle as low as 10% is feasible without a reduction in ignition quality. The corona discharge ignition system 20 can also reduce the average current used by up to 90% and the peak current by up to 75%. FIG. 6 also illustrates the inventive system 20 provides ignition in less time than the spark ignition systems.

As stated above, the corona discharge ignition system 20 of the present invention provides numerous benefits, in addition to reduced energy usage and related energy costs. Due to the lower peak and average currents, the electronic components of the system 20 may be simplified. For example, smaller charge storage capacitors and smaller filter components can be employed, compared to those employed in single event corona discharge ignition systems providing the continuous, un-pulsed corona discharge.

Another advantage provided by the pulsed corona discharge 24 is reduced arcing and thus higher voltage and volume of corona discharge 24, compared to the continuous, un-pulsed corona discharge. Oftentimes, when providing corona discharge 24 in a combustion chamber 42, conditions arise where at least one streamer of the corona discharge 24 encounters a grounded metal part, for example, if the piston 40 closely approaches the firing tip 34. In this case, current flows from the igniter 22 to ground creating an ionized path between the igniter 22 and ground, referred to as arcing, and the voltage at the firing tip 34 drops sharply. In addition, the ionized path formed between the igniter 22 and ground prevents the corona discharge 24 from taking any other path and the spatial extent of the corona discharge 24 becomes severely limited. Once arcing occurs, it cannot be dissipated unless the voltage supply is lowered enough for the current to stop flowing. This is typically below the voltage required for corona discharge 24 formation. Thus, to recover from arcing, the system 20 must stop providing the electrical energy to the igniter 22.

However, when providing the pulsed corona discharge 24, if the corona discharge 24 does encounter a grounded component and an ionized path to ground is formed, it will only last as long as the present pulse. When the pulse ends, the path will dissipate during the interval between pulses, wherein no electrical energy is provided to the igniter 22. The desirable corona discharge 24 will form again when the next pulse begins. Secondly, the duration of the pulses may be selected such that the corona discharge 24 does not have the time required to grow large enough to reach a grounded engine part. This allows use of a higher voltage corona discharge 24, benefits in ease of calibration, robustness against cyclic variability in engine operation, and allows a greater volume of corona discharge 24 to be produced.

Another aspect of the invention provides a method of igniting a fuel-air mixture in a combustion chamber 42 of a corona discharge ignition system 20. As alluded to above, the method includes providing a plurality of pulses of electrical energy having a radio frequency to an igniter 22, and providing a plurality of pulses of corona discharge 24 from the igniter 22.

In one embodiment, the method first includes providing electrical energy having a radio frequency from at least one of the power supplies 48, 50 to the corona drive circuit 52, including providing the electrical energy to the corona drive circuit 52 while providing the plurality of pulses of corona discharge 24. The method preferably includes continuously providing the electrical energy at a voltage of 10 to 150 volts from the high voltage power supply 50 to the local charge storage device 70 and transmitting pulses of the electrical energy each having a voltage of 10 to 150 from the local charge storage device 70 to the corona drive circuit 52.

As alluded to above, the method includes storing the electrical energy in the corona drive circuit 52 and activating the corona drive circuit 52 followed by de-activating the corona drive circuit 52 and then re-activating the corona drive circuit 52. The activating steps include providing one of the pulses of electrical energy to the igniter 22 and the de-activating steps include providing the interval wherein no electrical energy is provided to the igniter 22. The activating and deactivating steps are repeated to provided the pulsed corona discharge 24. In one embodiment, the method includes transforming the electrical energy into the AC current before providing the electrical energy to the igniter 22.

The method further includes providing the electrical energy from the corona drive circuit 52 to the igniter 22 for emitting the electrical field having a radio frequency of 700 kHz to 2 MHz and a voltage of 1,000 to 100,000 volts ionizing the fuel-air mixture and providing the corona discharge 24. Prior to transmitting the electrical energy to the igniter 22, the method includes transmitting the electrical energy from the corona drive circuit 52 to the LC circuit 46, and then transmitting the electrical energy from the LC circuit 46 to the igniter 22.

Also discussed above, the method of providing the corona discharge 24 includes determining the energy parameters of the electrical energy to be received by the igniter 22. Prior to providing the electrical energy to the igniter 22, the method includes transforming the electrical energy to meet the predetermined energy parameters. As stated above, the step of providing the electrical energy to the igniter 22 includes providing a plurality of pulses of the electrical energy to the igniter 22. The method of the present invention provides robust ignition using less energy, as well as the other benefits discussed above.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility. In addition, the reference numerals in the claims are merely for convenience and are not to be read in any way as limiting.

What is claimed is:

1. A corona discharge ignition system (20) for providing a corona discharge (24) to ignite a fuel-air mixture, comprising:
an igniter (22) for receiving electrical energy having a radio frequency and providing a corona discharge (24),
at least one power supply (48, 50) providing the electrical energy, and wherein the electrical energy received by said igniter (22) includes a plurality of pulses of the electrical energy and the corona discharge (24) includes a plurality of pulses of the corona discharge (24).

2. The system (20) of claim 1, wherein said igniter (22) emits a plurality of pulses of electrical field having a radio frequency ionizing a fuel-air mixture and providing said corona discharge (24).

3. The system (20) of claim 1 wherein said pulses of electrical energy received by said igniter (22) each have a duration of 1 microsecond to 2,500 microseconds.

4. The system (20) of claim 1 wherein said pulses of electrical energy received by said igniter (22) have a frequency being unlimited.

5. The system (20) of claim 1 wherein said pulses of electrical energy have a frequency of at least 400 Hertz.

6. The system (20) of claim 1 wherein each of said pulses of electrical energy have a voltage of at least 10 volts.

7. The system (20) of claim 1 wherein each of said pulses of electrical energy is spaced from the next one of said pulses by an interval of 1 microsecond to 2,500 microseconds wherein no electrical energy is received by said igniter (22).

8. The system (20) of claim 1 including a corona drive circuit (52) receiving the electrical energy from said at least one power supply (48, 50) and transforming the electrical energy to an AC voltage and providing the electrical energy to said igniter (22).

9. The system (20) of claim 8 including a controller (44) providing a drive control signal (58) instructing said corona drive circuit (52) to provide one of said pulses of electrical energy to said igniter (22) and instructing said corona drive circuit (52) to provide an interval between said pulse and the next pulse wherein no electrical energy is provided to said igniter (22) and instructing said corona drive circuit (52) to provide another one of said pulses of electrical energy to said igniter (22) after said interval.

10. The system (20) of claim 1 wherein said at least one power supply (48, 50) includes a main power supply (48) and a high voltage power supply (50) each supplying the electrical energy to said corona drive circuit (52), wherein the electrical energy supplied to said corona drive circuit (52) by said high voltage power supply (50) has a voltage of at least 10 volts.

11. The system (20) of claim 10 including a local charge storage device (70) continuously receiving electrical energy from said high voltage power supply (50) at a first voltage and storing the electrical energy and transmitting pulses of the electrical energy to said corona drive circuit (52) at a second voltage greater that the first voltage.

12. The system (20) of claim 1 wherein said at least one power supply (48, 50) provides the electrical energy to said igniter (22) while said igniter (22) provides said corona discharge (24).

13. The system (20) of claim 1 wherein the electrical energy provided to said igniter (22) is from 0.1 to 5 A.

14. A corona discharge ignition system (20) providing a radio frequency electrical field to ionize a portion of a fuel-air mixture and provide a corona discharge (24) to ignite the fuel-air mixture in a combustion chamber (42), comprising:
a cylinder block (36) and cylinder head (38) and a piston (40) presenting a combustion chamber (42) therebetween,
an igniter (22) disposed in said cylinder head (38) and extending into said combustion chamber (42) for receiving electrical energy having a radio frequency and predetermined energy parameters, wherein said energy parameters include voltage and frequency,
said igniter (22) emitting an electrical field having a radio frequency and a voltage of 1,000 to 100,000 volts ionizing a portion of a fuel-air mixture and providing a corona discharge (24),
said igniter (22) including an electrode (26) receiving the electrical energy and emitting the electrical field,
a corona drive circuit (52) for storing electrical energy and providing the electrical energy to said igniter (22),
a main power supply (48) supplying the electrical energy to said corona drive circuit (52) while said igniter (22) provides said corona discharge (24),
a variable high voltage power supply (50) separate from said main power supply (48) supplying electrical energy at a voltage of at least 10 volts to said corona drive circuit (52) while said igniter (22) provides said corona discharge (24),
a controller (44) transmitting a drive control signal (58) to said corona drive circuit (52) instructing said corona drive circuit (52) to transmit the electrical energy to said igniter (22),
an LC circuit (46) receiving the electrical energy from said corona drive circuit (52) and providing the electrical energy to said igniter (22),
said corona drive circuit (52) and said LC circuit (46) transforming the electrical energy provided by said power supplies (48, 50) to meet the predetermined energy parameters, and
the electrical energy received by said igniter (22) being a plurality of pulses of the electrical energy, wherein each of said pulses has a duration of 1 microsecond to 2,500 microseconds and is spaced from the next one of said pulses by an interval of 1 microseconds to 2500 microseconds wherein no electrical energy is provided to said igniter (22) and each of said pulses has a voltage of at least 10 volts.

15. A method of igniting a fuel-air mixture using corona discharge (24), comprising the steps of:
providing a plurality of pulses of electrical energy having a radio frequency to an igniter (22), and
providing a plurality of pulses of corona discharge (24) from the igniter (22).

16. The method of claim 15 including storing the electrical energy in a corona drive circuit (52) and activating the corona drive circuit (52) followed by de-activating the corona drive circuit (52) followed by re-activating the corona drive circuit (52), wherein the activating steps include providing one of the pulses of electrical energy to the igniter (22) and the de-activating step includes providing an interval wherein no electrical energy is provided to the igniter (22).

17. The method of claim 16 including continuously providing the electrical energy at a voltage of 10 to 150 volts from a high voltage power supply (50) to a local charge storage device (70) and transmitting pulses of the electrical energy each having a voltage of 10 to 150 from the local charge storage device (70) to the corona drive circuit (52).

18. The method of claim 15 including providing the electrical energy to the corona drive circuit (52) while providing the plurality of pulses of corona discharge (24).

19. The method of claim 15 including transforming the electrical energy into an AC voltage before providing the electrical energy to the igniter (22).

20. A method of igniting a fuel-air mixture in a combustion chamber (42) using corona discharge (24), comprising the steps of:
providing electrical energy having a radio frequency from at least one power supply (48, 50) to a corona drive circuit (52),
providing the electrical energy from the corona drive circuit (52) to an igniter (22) for emitting an electrical field having a radio frequency of 700 kHz to 2 MHz and a voltage of 1,000 to 100,000 volts ionizing a fuel-air mixture and providing a corona discharge (24),
providing the electrical energy from the at least one power supply to the corona drive circuit (52) while providing the corona discharge (24),
transmitting the electrical energy from the corona drive circuit (52) to an LC circuit (46),
transmitting the electrical energy from the LC circuit (46) to the igniter (22), vdetermining energy parameters of the electrical energy received by said igniter (22), wherein the energy parameters include voltage and frequency of the energy,
transforming the electrical energy to meet the predetermined energy parameters prior to providing the electrical energy to the igniter (22), and
the step of providing the electrical energy to the igniter (22) including providing a plurality of pulses of the electrical energy to the igniter (22).
